(19) United States
(12) Patent Application Publication
(10) Pub. No.: US 2012/0082245 A1
(43) Pub. Date: Apr. 5, 2012

(54) NETWORK BASEBAND SIGNAL TRANSMISSION APPARATUS USING AT LEAST TWO COAXIAL CABLES

(76) Inventor: CHIEN-CHUNG LEE, Chung Ho City (TW)

(21) Appl. No.: 12/898,682

(22) Filed: Oct. 5, 2010

(51) Int. Cl. H04B 3/00

(52) U.S. Cl. 375/257

(57) ABSTRACT

An apparatus uses at least two coaxial cables to transmit network baseband signals, particularly Ethernet baseband signals. The apparatus includes a first transmission device and a second transmission device. The first transmission device includes a first conversion module that is capable of transmitting and receiving Ethernet baseband signals. The second transmission device includes a second conversion module that is capable of transmitting Ethernet baseband signals to the first conversion module and receiving Ethernet baseband signals from the first conversion module. The first and second conversion modules are connected through at least two coaxial cables for transmission of Ethernet baseband signals. Through transmission of network baseband signals through coaxial cables, the advantages of reducing costs and maintaining high efficiency of transmission can be realized.

### TECHNICAL FIELD OF THE INVENTION

The present invention generally relates to a network baseband signal transmission apparatus, and more particularly to an apparatus that uses at least two coaxial cables to transmit network baseband signals to realize the advantages of reduced cost and high transmission efficiency.

### DESCRIPTION OF THE PRIOR ART

The quick development of internet system raises a problem of efficient communication between computers. To communicate between computers, a common communication protocol must be adopted by all the computers in communication. Among the known communication protocols, Ethernet protocol is one of the most commonly used hardware communication protocols.

The progress of technology brings new demand of increased transmission speed to suit all sorts of commercial needs. For such a purpose, optic fiber Ethernet is developed. With the optic fiber Ethernet, improved quality and speed of data transmission are realized.

The current version of Ethernet, however, suffers certain drawbacks, which must be further improved.

Although the transmission speed suits the needs of business use, yet additional transmission and receipt devices must be installed for a transmission distance exceeding 100 meters for optic fiber version of Ethernet. These transmission and receipt devices are expensive. A cheap alternative is using integrated circuits that perform modulation and demodulation to allow for high speed transmission of ultra high speed Ethernet. However, this measure does not actually achieve real ultra high speed. Apparently, improvement in required.

### SUMMARY OF THE INVENTION

The primary objective of the present invention is to provide a network baseband signal transmission apparatus using at least two coaxial cables, so as to realize signal transmission at a reduced cost.

Another objective of the present invention is to provide a network baseband signal transmission apparatus using at least two coaxial cables, which is of high transmission efficiency.

To achieve the above objectives, the present invention provides a network baseband signal transmission apparatus, which comprises a first transmission device and a second transmission device. The first transmission device comprises a first conversion module that is capable of transmitting and receiving Ethernet baseband signals. The second transmission device comprises a second conversion module that is capable of transmitting Ethernet baseband signals to the first conversion module and receiving Ethernet baseband signals from the first conversion module. The first and second conversion modules are connected through at least two coaxial cables for transmission of Ethernet baseband signals.

With such an arrangement that the present invention comprises a first transmission device and a second transmission device, which respectively comprise first conversion module that is capable of transmitting and receiving Ethernet baseband signals and a second conversion module that is capable of transmitting Ethernet basebands signals to the first conversion module and receiving Ethernet basebands signals from the first conversion module, through the first and second conversion modules, the first and second transmission devices can transmit network baseband signals through at least two coaxial cables for a distance exceeding 100 meters without the installation of optic fiber facility and at a transmission speed for transmitting baseband signals at the same level as Gigabit Ethernet. Since coaxial cables are cheaper than optic fiber facilities, the present invention provides a practical improvement of effectively reducing costs.

Further, the present invention uses the first and second conversion modules that are connected through coaxial cables for transmission of network baseband signals, through which a transmission speed at the same level as Gigabit Ethernet is realized, so that the present invention provides a practical improvement of high efficiency transmission.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of an apparatus according to a first embodiment of the present invention.

FIG. 2 is a block diagram of an apparatus according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

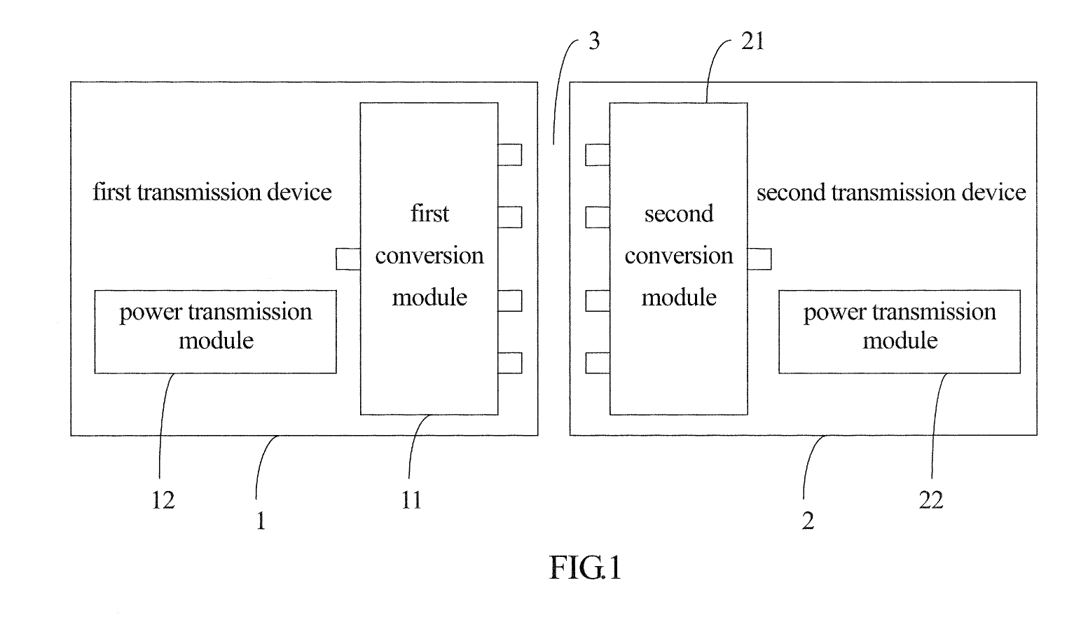

FIG. 1 shows a block diagram of an apparatus that uses at least two coaxial cables to realize transmission of network baseband signal according to a first preferred embodiment of the present invention. As shown in the drawing, the apparatus according to the present invention comprises the following constituent components, which will be described separately.

A first transmission device 1 comprises a first conversion module 11 that is capable of transmitting and receiving Ethernet baseband signals. Preferably, the first conversion module 11 comprises a passive circuit that consumes no electrical power. The first transmission device 1 further comprises a power transmission module 12 that is capable of transmitting electrical power. The first transmission device 1 may further comprise an input/output port complying with specifications of Gigabit Ethernet, 10 Gigabit Ethernet, 100 Gigabit Ethernet, 10M, 100M, and 10/100M.

A second transmission device 2 comprises a second conversion module 21 that is capable of transmitting Ethernet baseband signals to the first conversion module 11 and receiving Ethernet baseband signals from the first conversion module 11. Preferably, the second conversion module 21 comprises a passive circuit that consumes no electrical power. The second transmission device 2 further comprises a power transmission module 22 that is capable of transmitting electrical power. The second transmission device 2 may further comprise an input/output port complying with specifications of Gigabit Ethernet, 10 Gigabit Ethernet, 100 Gigabit Ethernet, 10M, 100M, and 10/100M.

As such, the first conversion module 11 is capable of transmitting and receiving Ethernet baseband signals with respect to the second conversion module 21 through at least two coaxial cables 3 (four such cables 3 being shown in the drawings).

Further, the first transmission device 1 and the second transmission device 2 may further comprise a Power-over-Ethernet (PoE) port, or an input/output port for mixed uncompressed high definition audio, video, and 100BASE-T. The network baseband signals are selectively 1000BASE-T or 1000BASE-TX.

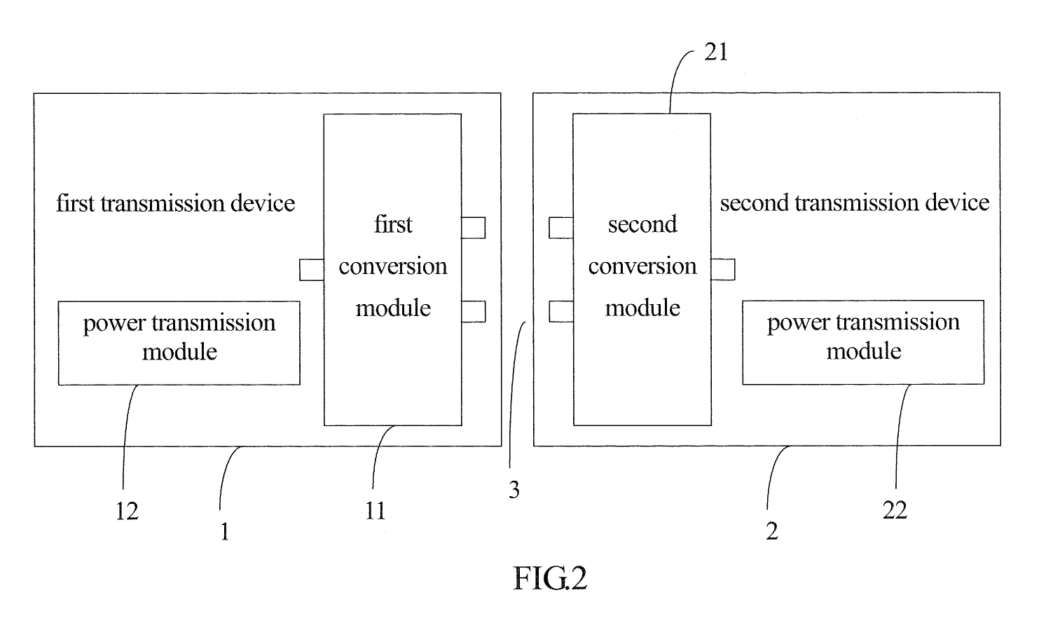

FIG. 2 shows a block diagram of an apparatus that uses at least two coaxial cables to realize transmission of network baseband signal according to a second preferred embodiment of the present invention. As shown in the drawing, the apparatus according to the present invention comprises the following constituent components, which will be described separately.

A first transmission device 1 comprises a first conversion module 11 that is capable of transmitting and receiving Ethernet baseband signals. Preferably, the first conversion module 11 comprises a passive circuit that consumes no electrical power. The first transmission device 1 further comprises a power transmission module 12 that is capable of transmitting electrical power. The first transmission device 1 may further comprise an input/output port complying with specifications of Gigabit Ethernet, 10 Gigabit Ethernet, 100 Gigabit Ethernet, 10M, 100M, and 10/100M.

A second transmission device 2 comprises a second conversion module 21 that is capable of transmitting Ethernet baseband signals to the first conversion module 11 and receiving Ethernet baseband signals from the first conversion module 11. Preferably, the second conversion module 21 comprises a passive circuit that consumes no electrical power. The second transmission device 2 further comprises a power transmission module 22 that is capable of transmitting electrical power. The second transmission device 2 may further comprise an input/output port complying with specifications of Gigabit Ethernet, 10 Gigabit Ethernet, 100 Gigabit Ethernet, 10M, 100M, and 10/100M.

As such, the first conversion module 11 is capable of transmitting and receiving Ethernet baseband signals with respect to the second conversion module 21 through at least two coaxial cables 3 (four such cables 3 being shown in the drawings).

Further, the first transmission device 1 and the second transmission device 2 may further comprise a Power-over-Ethernet (PoE) port, or an input/output port for mixed uncompressed high definition audio, video, and 100BASE-T. The network baseband signals are 1000BASE-T.

With the above described arrangement, the operation of the present invention will be described. The apparatus according to the present invention comprises a first transmission device 1 and a second transmission device 2, which comprise a first conversion module 11 and a second conversion module 21 respectively, the first conversion module 11 and the second conversion module 21 are capable of transmission and receipt of Ethernet baseband signals through at least four coaxial cables 3 or two coaxial cables. As such, since the costs of coaxial cables 3 are much cheaper than optic fiber facility and allow for signal transmission over 100 meters, the present invention can realize a transmission speed of the level of Gigabit Ethernet through the use of coaxial cables 3, so that the present invention is advantageous in cost saving and high efficiency of transmission.

Further, according to the present invention, the first transmission device 1 and the second transmission device 2 comprise power transmission modules 12, 22, which are capable of transmitting electrical power through the coaxial cables 3. As such, an additional value is provided by the present invention. Referring to the drawings, as compared to the known technologies, the present invention offers the following advantages:

(1) The present invention can realize Gigabit Ethernet transmission speed through coaxial cables 3 connecting between a first transmission device 1 and a second transmission device 2, making it effective for reducing costs for businesses and individuals. Further, according to the present invention, network baseband signals are transmitted through coaxial cables 3 at the same transmission standards as Gigabit Ethernet and thus a practical improvement of high efficiency transmission is provided.

(2) In practical applications, the present invention uses a first transmission device 1 and a second transmission device 2 that are connected by coaxial cables 3 to transmit Ethernet baseband signals and a transmission distance exceeding 100 meters can be realized through such an arrangement without any influence on the transmission efficiency.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A network baseband signal transmission apparatus, comprising:
a first transmission device, which comprises a first conversion module for transmitting and receiving Ethernet baseband signal; and
a second transmission device, which comprises a second conversion module for transmitting Ethernet baseband signals to the first conversion module and receiving Ethernet baseband signal from the first conversion module;
wherein the first conversion module is allowed to transmit and receive Ethernet baseband signals with respect to the second conversion module through at least two coaxial cables.

2. The network baseband signal transmission apparatus according to claim 1, wherein the first conversion module comprises a passive circuit.

3. The network baseband signal transmission apparatus according to claim 1, wherein the second conversion module comprises a passive circuit.

4. The network baseband signal transmission apparatus according to claim 1, wherein the first transmission device and the second transmission device comprise power transmission modules respectively for transmitting electrical power through the coaxial cables.

5. The network baseband signal transmission apparatus according to claim 1, wherein the first transmission device comprises an input/output port complying with the specifications of Gigabit Ethernet, 10 Gigabit Ethernet, 100 Gigabit Ethernet, 10M, 100M, and 10/100M.

6. The network baseband signal transmission apparatus according to claim 1, wherein the second transmission device comprises an input/output port complying with the specifications of Gigabit Ethernet, 10 Gigabit Ethernet, 100 Gigabit Ethernet, 10M, 100M, and 10/100M.

7. The network baseband signal transmission apparatus according to claim 1, wherein the first transmission device and the second transmission device each comprise a Power-over-Ethernet port.

8. The network baseband signal transmission apparatus according to claim 1, wherein the network baseband signals are 100BASE-T or 1000BASE-TX.

9. The network baseband signal transmission apparatus according to claim 1, wherein the network baseband signals are 100BASE-T.

10. The network baseband signal transmission apparatus according to claim 1, wherein the first transmission device and the second transmission device each further comprise an input/output port for mixed signals of uncompressed high definition video, audio, and 100BASE-T.
